(19) United States
(12) Patent Application Publication
(10) Pub. No.: US 2026/0037784 A1
(43) Pub. Date: Feb. 5, 2026

(54) IMPLEMENTING SCALABLE STORAGE OF PERSONALIZED MACHINE LEARNING MODELS

(71) Applicant: Lemon Inc., Grand Cayman (KY)

(72) Inventors: Shen Sang, Los Angeles, CA (US); Tiancheng Zhi, Los Angeles, CA (US); Jing Liu, Los Angeles, CA (US); Linjie Luo, Los Angeles, CA (US)

(21) Appl. No.: 18/792,519

(22) Filed: Aug. 1, 2024

(51) Int. Cl. G06N 3/0495; G06N 3/045

(52) U.S. Cl. CPC G06N 3/0495; G06N 3/045

(57) ABSTRACT

The present disclosure describes techniques for implementing scalable storage of personalized machine learning models. A plurality of personalized machine learning models are generated based on finetuning a base machine learning model. The base machine learning model comprises a first set of layers. Each of the plurality of personalized machine learning models comprises a second set of layers. A plurality of difference models are generated by computing differences between the first set of layers and the second set of layers. The plurality of difference models corresponds to the plurality of personalized machine learning models, respectively. The plurality of difference models are processed by compressing parameters of each of the plurality of difference models to generate a plurality of compressed models. The plurality of compressed models are stored for future use of the plurality of personalized machine learning models.

### BACKGROUND

Machine learning models are increasingly being used across a variety of industries to perform a variety of different tasks. Such tasks may include audio or vision related tasks. Improved techniques for generating and storing personalized machine learning models are desirable.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing scalable storage of personalized machine learning models in accordance with the present disclosure.

FIG. 2 shows an example system for implementing scalable storage of personalized machine learning models in accordance with the present disclosure.

FIG. 3 shows an example system for implementing scalable storage of personalized machine learning models in accordance with the present disclosure.

FIG. 4 shows an example system for recovering personalized machine learning models in accordance with the present disclosure.

FIG. 5 shows an example process for implementing scalable storage of personalized machine learning models in accordance with the present disclosure.

FIG. 6 shows an example process for generating difference models in accordance with the present disclosure.

FIG. 7 shows an example process for generating difference models in accordance with the present disclosure.

FIG. 8 shows an example process for implementing scalable storage of personalized machine learning models in accordance with the present disclosure.

FIG. 9 shows an example process for implementing scalable storage of personalized machine learning models in accordance with the present disclosure.

FIG. 10 shows an example process for implementing scalable storage and recovery of personalized machine learning models in accordance with the present disclosure.

FIG. 11 shows an example process for implementing scalable storage and recovery of personalized machine learning models in accordance with the present disclosure.

FIG. 12 shows an example computing device which may be used to perform any of the techniques disclosed herein.

### DETAILED DESCRIPTION OF ILLUSTRATIVE EMBODIMENTS

Machine learning models can consume a large amount of storage space. For example, storing a single machine learning model, such as a large vision foundation model, can consume anywhere from four to eight gigabytes (GB) of storage. For some personalization applications, a single base machine learning model can be personalized, or fine-tuned, for a large number of different users. Each personalized machine learning model consumes a similar amount of storage space as the base machine learning model. However, the total amount of storage space available is often limited. There is not enough storage space to store a large number of personalized machine learning models, such as thousands or millions of personalized machine learning models. The lack of sufficient storage space becomes increasingly problematic as the number of users for which personalized machine learning models need to be generated increases.

Low-Rank Adaptation (LoRA) can be used to remedy this issue. LoRa can be used to finetune a base machine learning model. Each personalized machine learning model can be learned in a LoRA file. Each LoRA file has a fewer number of parameters than the base machine learning model. As such, each LoRA file is usually much smaller (e.g., 300 MB) than the base machine learning model. This can remedy the storage issue described above. However, in most personalization applications, LoRA training is sub-optimal and cannot meet quality requirements. As a result, full finetuning of the base machine learning model is still the most optimal way to generate personalized machine learning models, and the storage issue described above persists. As such, improved techniques for implementing scalable storage of personalized machine learning models are needed.

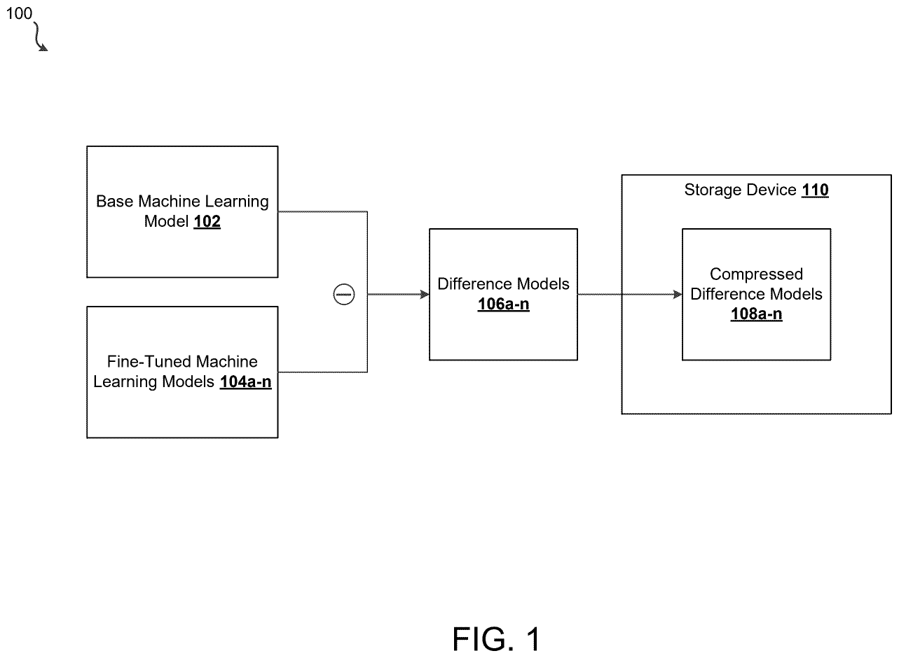

Described herein are improved techniques for implementing scalable storage of personalized machine learning models. FIG. 1 shows an example system 100 for implementing scalable storage of personalized machine learning models in accordance with the present disclosure. The system 100 includes a base machine learning model 102. The base machine learning model 102 can include any machine learning model, including but not limited to a large vision foundation model. The large vision foundation model can be pre-trained to generate images, such as new images from scratch. The large vision foundation model can include a stable diffusion model, a stable diffusion XL model, or any other large vision foundation model.

The base machine learning model 102 can be fine-tuned to generate a plurality of fine-tuned (e.g., personalized) machine learning models 104a-n. Each of the plurality of fine-tuned machine learning models 104a-n can correspond to a particular user from a plurality of users. For example, the base machine learning model 102 can be fine-tuned for a first user from the plurality of users to generate the fine-tuned machine learning model 104a, the base machine learning model 102 can be fine-tuned for a second user from the plurality of users to generate the fine-tuned machine learning model 104b, the base machine learning model 102 can be fine-tuned for a third user from the plurality of users to generate the fine-tuned machine learning models 104c, and so on.

In embodiments, each of the plurality of fine-tuned machine learning models 104a-n can be generated by finetuning the base machine learning model 102 based on at least one image received from (e.g., input by) the corresponding user. The at least one image can include an image of the corresponding user, such as an image of a face of the corresponding user. For example, the fine-tuned machine learning model 104a can be generated based on fine-tuning the base machine learning model 102 using at least one image received from the first user, the fine-tuned machine learning model 104b can be generated based on fine-tuning the base machine learning model 102 using at least one image received from the second user, the fine-tuned machine learning model 104c can be generated based on fine-tuning the base machine learning model 102 using at least one image received from the third user, and so on.

Fine-tuning the base machine learning model 102 can include adjusting the parameters, such as the weights of the parameters, of the base machine learning model 102. The base machine learning model 102 can include a first set of layers. Each layer in the first set of layers can be associated with its own parameters. For example, a first layer in the first set of layers can be associated with first parameters, a second layer in the first set of layers can be associated with second parameters, a third layer in the first set of layers can be associated with third parameters, a fourth layer in the first set of layers can be associated with fourth parameters and so on.

The first set of layers of the base machine learning model 102 can be fine-tuned to generate the plurality of fine-tuned machine learning models 104a-n. Each of the plurality of fine-tuned machine learning models 104a-n can be associated with a second set of layers. Each layer in the second set of layers can be associated with its own parameters. For example, a first layer in the second set of layers can be associated with fifth parameters, a second layer in the second set of layers can be associated with sixth parameters, a third layer in the second set of layers can be associated with seventh parameters, a fourth layer in the second set of layers can be associated with eighth parameters, and so on.

Fine-tuning the base machine learning model 102 can include adjusting one or more of the parameters in any (or all) of the first set of layers. The resulting fine-tuned machine learning model can include the same quantity of layers as the base machine learning model 102, but the layers of the fine-tuned machine learning model can be associated with adjusted (e.g., different) parameters.

For example, the first set of layers can include four layers (e.g., Layer A1, Layer B1, Layer C1, Layer D1). Layer A1 can be associated with first parameters, Layer B1 can be associated with second parameters, Layer C1 can be associated with third parameters, and Layer DI can be associated with fourth parameters. The first, second, third, and/or fourth parameters can be adjusted to generate any one of the plurality of fine-tuned machine learning models 104a-n. Each of the resulting fine-tuned machine learning models can also include four layers (e.g., Layer A2, Layer B2, Layer C2, Layer D2). Layer A2 can correspond to Layer A1 (e.g., Layer A1 is the first layer of the base machine learning model 102 and Layer A2 is the first layer of a resulting fine-tuned machine learning model). Layer B2 can correspond to Layer B1 (e.g., Layer B1 is the second layer of the base machine learning model 102 and Layer B2 is the second layer of the resulting fine-tuned machine learning model). Layer C2 can correspond to Layer C1 (e.g., Layer C1 is the third layer of the base machine learning model 102 and Layer C2 is the third layer of the resulting fine-tuned machine learning model). Layer D2 can correspond to Layer D1 (e.g., Layer D1 is the fourth layer of the base machine learning model 102 and Layer D2 is the fourth layer of the resulting fine-tuned machine learning model). Layer A2 can be associated with fifth parameters, Layer B2 can be associated with sixth parameters, Layer C2 can be associated with seventh parameters, and Layer D2 can be associated with eighth parameters. One or more of Layer A2, Layer B2, Layer C2, Layer D2 can be associated with different parameters than the corresponding layer in the first set of layers. For example, the fifth parameters can be different from the first parameters, the sixth parameters can be different from the second parameters, the seventh parameters can be different from the third parameters, and/or the eighth parameters can be different from the fourth parameters.

A plurality of difference models 106a-n can be generated. The plurality of difference models 106a-n can correspond to the plurality of fine-tuned machine learning models 104a-n, respectively. For example, the difference model 106a can correspond to the fine-tuned machine learning model 104a, the difference model 106b can correspond to the fine-tuned machine learning model 104b, the difference model 106c can correspond to the fine-tuned machine learning model 104c, and so on.

The plurality of difference models 106a-n can be generated by computing differences between the first set of layers and each of the second set of layers. For example, to generate the difference model 106a corresponding to the fine-tuned machine learning model 104a, differences between the first set of layers and the second set of layers of the fine-tuned machine learning model 104a can be computed. Likewise, to generate the difference model 106b corresponding to the fine-tuned machine learning model 104b, differences between the first set of layers and the second set of layers of the fine-tuned machine learning model 104b can be computed, and so on. Calculating the differences between the first set of layers and a particular second set of layers can include calculating the differences between the parameters (e.g., the weights of the parameters) of the first set of layers and the parameters (e.g., the weights of the parameters) of the particular second set of layers.

Referring again to the example described above (where the first set of layers includes Layer A1 associated with first parameters, Layer B1 associated with second parameters, Layer C1 associated with third parameters, and Layer D1 associated with fourth parameters, and the second set of layers corresponding to a particular fine-tuned machine learning model includes Layer A2 associated with fifth parameters, Layer B2 associated with sixth parameters, Layer C2 associated with seventh parameters, and Layer D2 associated with eight parameters), calculating the differences between the first set of layers and the second set of layers can include calculating the differences between the fifth parameters and the first parameters, calculating the differences between the sixth parameters and the second parameters, calculating the differences between the seventh parameters and the third parameters, and/or calculating the differences between the eighth parameters and the fourth parameters.

The resulting difference model (e.g., 106a) can include four layers (e.g., A3, B3, C3, and D3). The layer A3 can be represented by a high-rank matrix indicative of the differences between the fifth parameters and the first parameters. The layer B3 can be represented by a high-rank matrix indicative of the differences between the sixth parameters and the second parameters. The layer C3 can be represented by a high-rank matrix indicative of the differences between the seventh parameters and the third parameters. The layer D3 can be represented by a high-rank matrix indicative of the differences between the eighth parameters and the fourth parameters.

The plurality of difference models 106a-n can be compressed to generate a plurality of compressed models 108a-n. Compressing the plurality of difference models 106a-n can include compressing parameters of each of the plurality of difference models 106a-n to generate a plurality of compressed models. Compressing parameters of each of the plurality of difference models 106a-n can include processing the plurality of difference models 106a-n. Processing the plurality of difference models 106a-n can include compressing parameters of each of the plurality of difference models 106a-n to generate the plurality of compressed models 108a-n. For example, the parameters of the difference model 106a can be compressed to generate the compressed model 108a, the parameters of the difference model 106b can be compressed to generate the compressed model 108b, the parameters of the difference model 106c can be compressed to generate the compressed model 108c, and so on.

The plurality of compressed models 108a-n can be stored. The plurality of compressed models 108a-n can be stored in a storage device 110. The base machine learning model 102 can be stored in the storage device 110. The plurality of compressed models 108a-n can be stored for future use of the plurality of fine-tuned machine learning models 104a-n. Storing the plurality of compressed models 108a-n instead of the plurality of fine-tuned machine learning models 104a-n can minimize storage costs without affecting performance quality of the plurality of fine-tuned machine learning models 104a-n. For example, storing the plurality of compressed models 108a-n along with the base machine learning model 102 can, in total, consume approximately 200 MB of storage in the storage device 110. In contrast, if each of the plurality of fine-tuned machine learning models 104a-n were instead to be stored separately, each of the plurality of fine-tuned machine learning models 104a-n could consume around 4-8 GB of storage.

If a user from the plurality of users wants to utilize his/her personalized machine learning model (e.g., the corresponding fine-tuned machine learning model from the plurality of fine-tuned machine learning models 104a-n), the corresponding compressed model from the plurality of compressed models 108a-n can be used to restore (e.g., recover) the corresponding fine-tuned machine learning model. For example, a first user from the plurality of users can be associated with the fine-tuned machine learning model 104a. The fine-tuned machine learning model 104a can be associated with the compressed model 108a. The compressed model 108a can be used to restore the fine-tuned machine learning model 104a so that the first user can utilize the fine-tuned machine learning model 104a. For example, restoring the fine-tuned machine learning model 104a can include decompressing the compressed model 108a to the difference model 106a and adding the difference model 106a back to the base machine learning model 102.

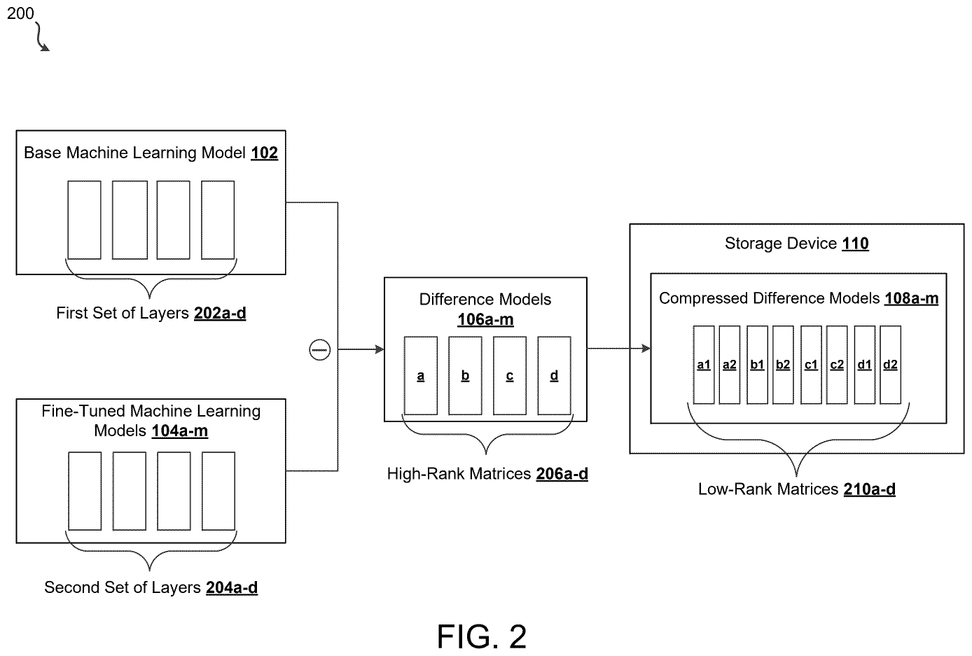

FIG. 2 shows an example system 200 for implementing scalable storage of personalized machine learning models in accordance with the present disclosure. As described above, the base machine learning model 102 can be fine-tuned to generate the plurality of fine-tuned (e.g., personalized) machine learning models 104a-m. The base machine learning model 102 can include a first set of layers, e.g., a first set of layers 202a-d. Each layer in the first set of layers 202a-d can be associated with its own parameters. For example, the first layer 202a can be associated with first parameters, the second layer 202b can be associated with second parameters, the third layer 202c can be associated with third parameters, and the fourth layer 202d can be associated with fourth parameters.

Each layer in the first set of layers 202a-d can be represented by a high-rank matrix, such that the base machine learning model 102 can be represented by a plurality of high-rank (e.g., large) matrices. For example, the first layer 202a can be represented by a first high-rank matrix indicative of the first parameters, the second layer 202b can be represented by a second high-rank matrix indicative of the second parameters, the third layer 202c can be represented by a third high-rank matrix indicative of the third parameters, and the fourth layer 202d can be represented by a fourth high-rank matrix indicative of the fourth parameters.

The first set of layers 202a-d can be fine-tuned to generate the plurality of fine-tuned machine learning models 104a-m. Each of the plurality of fine-tuned machine learning models 104a-m can be associated with its own second set of layers, a second set of layer 204a-d. For example, the fine-tuned machine learning model 104a can be associated with a unique set of layers 204a-d, the fine-tuned machine learning model 104b can be associated with a unique second set of layers 204a-d, the fine-tuned machine learning model 104c can be associated with a unique second set of layers 204a-d, and so on. Each layer in the second set of layers 204a-d can be associated with its own parameters. For example, the first layer 204a can be associated with fifth parameters, the second layer 204b can be associated with sixth parameters, the third layer 204c can be associated with seventh parameters, the fourth layer 204d can be associated with eighth parameters, and so on.

Each layer in each of the second set of layers 204a-d can be represented by a high-rank matrix, such that each of the plurality of fine-tuned machine learning models 104a-m can be represented by a plurality of high-rank matrices. For example, the first layer 204a can be represented by a first high-rank matrix indicative of the fifth parameters, the second layer 204b can be represented by a second high-rank matrix indicative of the sixth parameters, the third layer 204c can be represented by a third high-rank matrix indicative of the seventh parameters, and the fourth layer 204d can be represented by a fourth high-rank matrix indicative of the eighth parameters.

The plurality of difference models 106a-m can be generated. The plurality of difference models 106a-m can correspond to the plurality of fine-tuned machine learning models 104a-m, respectively. For example, the difference model 106a can correspond to the fine-tuned machine learning model 104a, the difference model 106b can correspond to the fine-tuned machine learning model 104b, the difference model 106c can correspond to the fine-tuned machine learning model 104c, and so on.

The plurality of difference models 106a-m can be generated by computing differences between the first set of layers 202a-d and each of the second set of layers 204a-d. For example, to generate the difference model 106a corresponding to the fine-tuned machine learning model 104a, differences between the first set of layers 202a-d and the second set of layers 204a-d of the fine-tuned machine learning model 104a can be computed. Calculating the differences between the first set of layers 202a-d and a particular second set of layers 204a-d can include calculating the differences between the parameters (e.g., the weights of the parameters) of the first set of layers 202a-d and the parameters (e.g., the weights of the parameters) of the particular second set of layers 204a-d. Calculating the differences between the parameters (e.g., the weights of the parameters) of the first set of layers 202a-d and the parameters (e.g., the weights of the parameters) of the particular second set of layers 204a-d can include computing differences between the high-rank matrices representing the first set of layers 202a-d and the high-rank matrices representing the second set of layers 204a-d.

The resulting plurality of difference models 106a-m can include the same number of layers as the first set of layers 202a-d and the second sets of layers 204a-d. Each of the layers of the plurality of difference models 106a-m can be represented by a high-rank (e.g., large) matrix, such that each of the plurality of difference models 106a-m can be represented by a plurality of high-rank matrices 206a-d. For example, if the difference model 106a includes four layers, the difference model 106a can be represented by four high-rank matrices. Each of the plurality of high-rank matrices 206a-d can indicate the difference between the parameters associated with the corresponding layer in the base machine learning model 102 and in the fine-tuned machine learning model 104a. For example, the high-rank matrix 206a can indicate the differences between the fifth parameters and the first parameters, the high-rank matrix 206b can indicate the differences between the sixth parameters and the second parameters, the high-rank matrix 206c can indicate calculating the differences between the seventh parameters and the third parameters, and the high-rank matrix 206d can indicate the differences between the eighth parameters and the fourth parameters.

The plurality of difference models 106a-m can be compressed to generate a plurality of compressed models 108a-m. Compressing the plurality of difference models 106a-m can include compressing parameters of each of the plurality of difference models 106a-m. Compressing parameters of each of the plurality of difference models 106a-m can include decomposing the parameters of each of the plurality of difference models 106a-m into low-rank matrices 210a-d. The low-rank matrices 210a-d can have a lower size or rank than the high-rank matrices 206a-d.

Decomposing the parameters of each of the plurality of difference models 106a-m can include decomposing the high-rank matrix 206a into two low-rank matrices (e.g., 210a1 and 210a2), decomposing the high-rank matrix 206b into two low-rank matrices (e.g., 210b1 and 21012), decomposing the high-rank matrix 206c into two low-rank matrices (e.g., 210c1 and 210c2), and decomposing the high-rank matrix 206d into two low-rank matrices (e.g., 210d1 and 210d2. Each of the plurality of compressed difference models 108a-m can include the two low-rank matrices for each layer. The plurality of compressed difference models 108a-m can be stored in the storage device 110.

Each of the high-rank matrices 206a-d of each difference model can be decomposed into two low-ranked matrices using a singular value decomposition (SVD) algorithm, for example. Given an input high-rank matrix M (a matrix of shape m×n), such as one of the high-rank matrices 206a-d, and a rank r (a rank of the final low-rank matrix), the SVD algorithm can be represented by the following. A matrix Y can be determined, where Y=M⊗Ω. Ω is a random matrix sampled from the Gaussian distribution having a shape n×r. QR decomposition can be performed over the matrix Y to determine a matrix X, where X=Q^{T}⊗M. The singular value singular decomposition of matrix X can be determined to generate low-rank matrices A and B, where the singular value singular decomposition of matrix X can be represented as SDV(X)=U.S.V. The low-rank matrix A can be represented as A=Q⊗V⊗S and can have a shape of m×r. The low-rank matrix B can be represented as B=U and can have a shape of n×r.

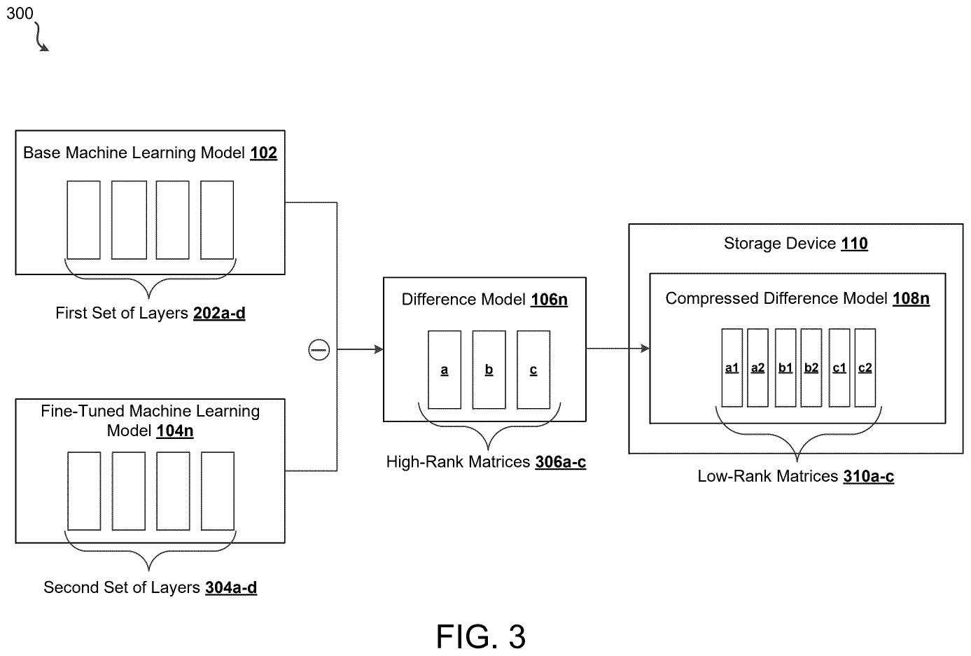

FIG. 3 shows an example system 300 for implementing scalable storage of personalized machine learning models in accordance with the present disclosure. In embodiments, a drop-out mechanism can be implemented during the generation of the plurality of difference models 106a-n. If a difference between a certain layer of the first set of layers and the second set of layers in one of the plurality of fine-tuned machine learning models 104a-n is less than a threshold, the certain layer can be dropped out from the corresponding different models.

For example, as shown in FIG. 3, the difference model 106n corresponding to the fine-tuned machine learning model 104n can be generated by computing differences between the first set of layers 202a-d and the second set of layers 304a-d of the fine-tuned machine learning model 104n. As described above, each layer in the first set of layers 202a-d can be associated with its own parameters. The first layer 202a can be associated with first parameters, the second layer 202b can be associated with second parameters, the third layer 202c can be associated with third parameters, and the fourth layer 202d can be associated with fourth parameters. Each layer in the second set of layers 302a-d can similarly be associated with its own parameters. The first layer 304a can be represented by a first high-rank matrix indicative of the fifth parameters, the second layer 304b can be represented by a second high-rank matrix indicative of the sixth parameters, the third layer 304c can be represented by a third high-rank matrix indicative of the seventh parameters, and the fourth layer 304d can be represented by a fourth high-rank matrix indicative of the eighth parameters.

To generate the difference model 106n, differences between the first set of layers 202a-d and the second set of layers 304a-d can be computed. Calculating the differences between the first set of layers 202a-d and the second set of layers 304a-d can include calculating the differences between the parameters (e.g., the weights of the parameters) of the first set of layers 202a-d and the parameters (e.g., the weights of the parameters) of the second set of layers 304a-d. Calculating the differences between the first set of layers 202a-d and the second set of layers 304a-d can include calculating the differences between the fifth parameters and the first parameters, calculating the differences between the sixth parameters and the second parameters, calculating the differences between the seventh parameters and the third parameters, and/or calculating the differences between the eighth parameters and the fourth parameters.

It can be determined whether a difference between each layer of the first set of layers 202a-d and the corresponding layer in the second set of layers 304a-d satisfies a predetermined threshold. For example, it can be determined whether the differences between the fifth parameters and the first parameters satisfy the threshold, whether the differences between the sixth parameters and the second parameters satisfy the threshold, whether the differences between the seventh parameters and the third parameters satisfy the threshold, and/or whether the differences between the eighth parameters and the fourth parameters satisfy the threshold. If the difference between a certain layer of the first set of layers 202a-d and the corresponding layer in the second set of layers 304a-d does not satisfy (e.g., is less than) the predetermined threshold, the certain layer can be dropped out of the difference model 106n.

In the example of FIG. 3, the differences between the eighth parameters (corresponding to the layer 304d) and the fourth parameters (corresponding to the layer 202d) do not satisfy the threshold. As such, the difference model 106n does not include a high-rank matrix corresponding to the layer 202d and the layer 304d. Instead, the difference model 106n only includes three high-rank matrices: a first high-rank matrix 306a representing the differences between the fifth parameters and the first parameters, a second high-rank matrix 306b representing the differences between the sixth parameters and the second parameters, and a third high-rank matrix 306c representing the differences between the seventh parameters and the third parameters.

Because the difference model 106n does not include a high-rank matrix corresponding to the layer 202d and the layer 304d, the compressed difference model 108n corresponding to the difference model 106n does not include low-rank matrices indicative of the differences between the eighth parameters (corresponding to the layer 304d) and the fourth parameters (corresponding to the layer 202d). Instead, the compressed difference model 108n includes a plurality of low-rank matrices 310a-c. The plurality of low-rank matrices 310a-c can include two low-rank matrices (e.g., 310a1 and 310a2) corresponding to the first high-rank matrix 306a, two low-rank matrices (e.g., 310b1 and 310b2) corresponding to the second high-rank matrix 306b, and two low-rank matrices (e.g., 310c1 and 310c2) corresponding to the third high-rank matrix 306d.

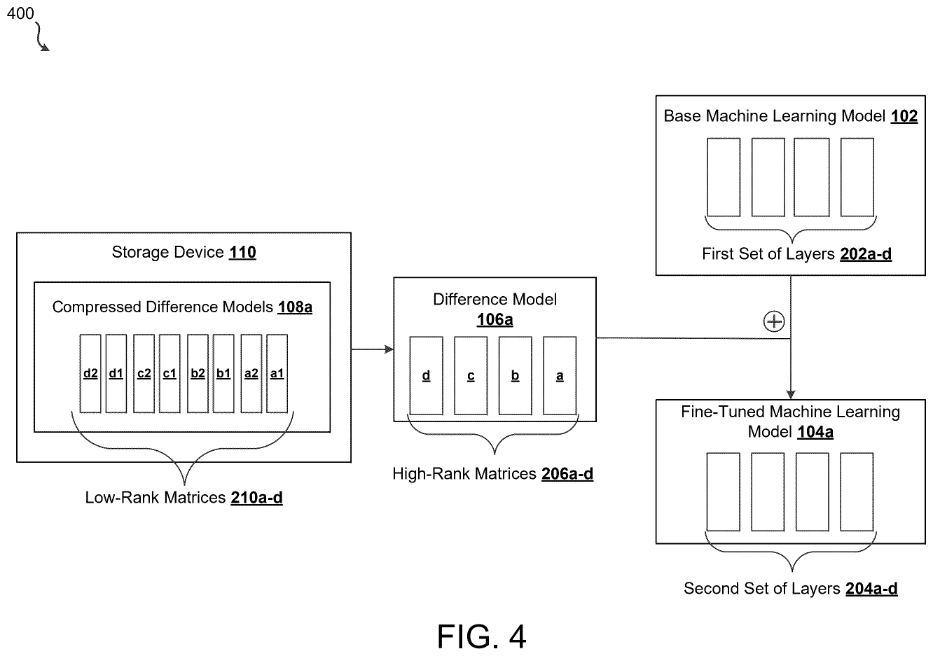

FIG. 4 shows an example system 400 for recovering personalized machine learning models in accordance with the present disclosure. If a user from the plurality of users wants to utilize his/her personalized machine learning model (e.g., the corresponding fine-tuned machine learning model from the plurality of fine-tuned machine learning models 104a-n), the corresponding compressed model from the plurality of compressed models 108a-n can be used to restore (e.g., recover) the corresponding fine-tuned machine learning model.

For example, a first user from the plurality of users can be associated with the fine-tuned machine learning model 104a. The fine-tuned machine learning model 104a can be associated with the compressed model 108a. The compressed model 108a can be used to restore the fine-tuned machine learning model 104a so that the first user can utilize the fine-tuned machine learning model 104a. For example, restoring the fine-tuned machine learning model 104a can include decompressing the compressed model 108a into the difference model 106a. Decompressing the compressed model 108a into the difference model 106a can include decompressing the low-rank matrices 210a-d into the high-rank matrices 206a-d. For example, the low-rank matrices 210a1 and 210a2 can be decompressed into the high-rank matrix 206a, the low-rank matrices 210b1 and 210b2 can be decompressed into the high-rank matrix 206b, the low-rank matrices 210c1 and 210c2 can be decompressed into the high-rank matrix 206c, and the low-rank matrices 210d1 and 210d2 can be decompressed into the high-rank matrix 206d.

The difference model 106a can be added back to the base machine learning model 102. Adding the difference model 106a back to the base machine learning model 102 can include adding the difference model 106a to the first set of layers 202a-d of the base machine learning model 102. Adding the difference model 106a to the first set of layers 202a-d of the base machine learning model 102 can include adding the high-rank matrix 206a into the layer 202a to recover the layer 204a of the fine-tuned machine learning model 104a, adding the high-rank matrix 206b into the layer 202b to recover the layer 204b of the fine-tuned machine learning model 104a, adding the high-rank matrix 206c into the layer 202c to recover the layer 204c of the fine-tuned machine learning model 104a, and adding the high-rank matrix 206d into the layer 202d to recover the layer 204d of the fine-tuned machine learning model 104a. The first user can utilize the recovered fine-tuned machine learning model 104a, such as to generate images.

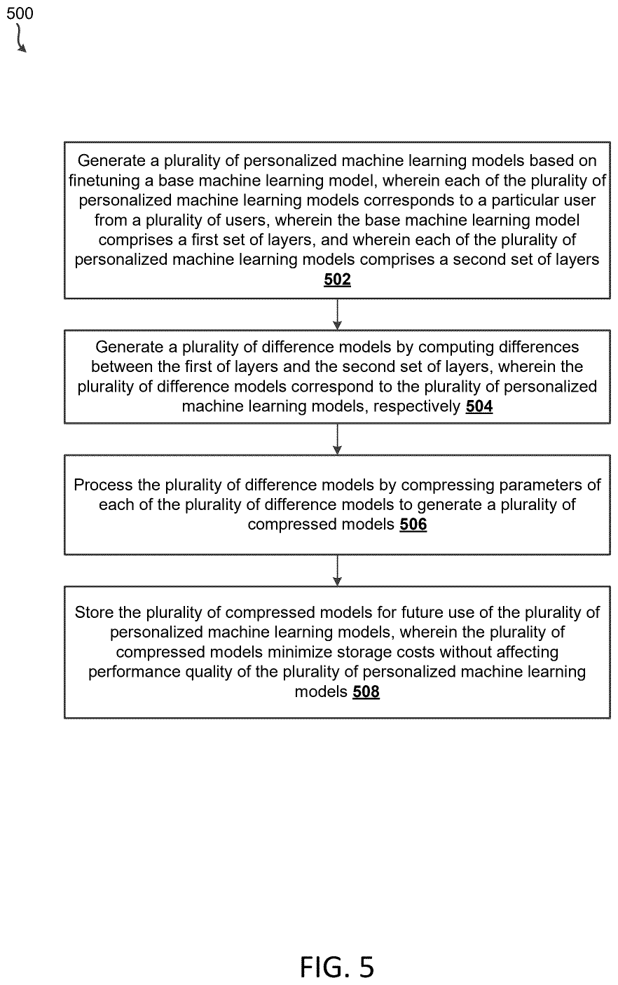

FIG. 5 illustrates an example process 500 for implementing scalable storage of personalized machine learning models. Although depicted as a sequence of operations in FIG. 5, those of ordinary skill in the art will appreciate that various embodiments may add, remove, reorder, or modify the depicted operations.

At 502, a plurality of personalized machine learning models (e.g., the plurality of fine-tuned machine learning models 104a-n) can be generated. The plurality of personalized machine learning models can be generated based on finetuning a base machine learning model (e.g., the base machine learning model 102). Each of the plurality of personalized machine learning models can correspond to a particular user from a plurality of users. The base machine learning model can include a first set of layers (e.g., the first set of layers 202a-d). Each of the plurality of personalized machine learning models can include a second set of layers (e.g., the second set of layers 204a-d). Each of the plurality of personalized machine learning models can include a unique second set of layers (e.g., a second set of layers that is different from the other second sets of layers).

At 504, a plurality of difference models (e.g., the plurality of difference models 106a-n) can be generated. The plurality of difference models can correspond to the plurality of personalized machine learning models, respectively. For example, each of the plurality of difference models can correspond to one of the plurality of personalized machine learning models. The plurality of difference models can be generated by computing differences between the first set of layers and the second set of layers. Computing the differences between the first set of layers and a particular second set of layers can include calculating the differences between the parameters (e.g., the weights of the parameters) of the first set of layers and the parameters (e.g., the weights of the parameters) of the particular second set of layers.

At 506, the plurality of difference models can be processed. The plurality of difference models can be processed by compressing parameters of each of the plurality of difference models. The plurality of difference models can be processed to generate a plurality of compressed models (e.g., the plurality of compressed models 108a-n). For example, the parameters of a first difference model from the plurality of difference models can be compressed to generate a first compressed model from the plurality of compressed models, the parameters of a third difference model from the plurality of difference models can be compressed to generate a third compressed model from the plurality of compressed models, and so on.

At 508, the plurality of compressed models can be stored. The plurality of compressed models can be stored in a storage device (e.g., the storage device 110). The plurality of compressed models can be stored for future use of the plurality of personalized machine learning models. Storing the plurality of compressed models instead of the plurality of personalized machine learning models minimizes storage costs without affecting performance quality of the plurality of personalized machine learning models.

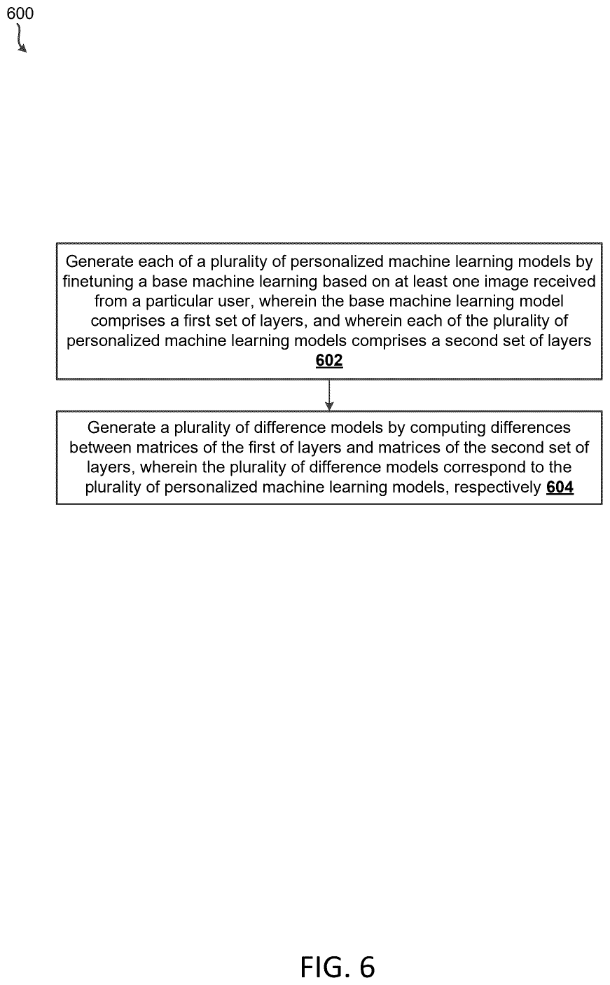

FIG. 6 illustrates an example process 600 for generating difference models in accordance with the present disclosure. Although depicted as a sequence of operations in FIG. 6, those of ordinary skill in the art will appreciate that various embodiments may add, remove, reorder, or modify the depicted operations.

At 602, a plurality of personalized machine learning models (e.g., the plurality of fine-tuned machine learning models 104a-n) can be generated. The plurality of personalized machine learning models can be generated based on finetuning a base machine learning model (e.g., the base machine learning model 102). Each of the plurality of personalized machine learning models can correspond to a particular user from a plurality of users. Each of the plurality of personalized machine learning models can be generated by finetuning the base machine learning based on at least one image received from the corresponding user from the plurality of users. For example, each user from the plurality of users can upload at least one image, such as an image of his or her face. The image(s) uploaded by each user from the plurality of users can be used to fine-tune the base machine learning model. The base machine learning model can include a first set of layers (e.g., the first set of layers 202a-d). Each of the plurality of personalized machine learning models can include a second set of layers (e.g., the second set of layers 204a-d). Each of the plurality of personalized machine learning models can include a unique second set of layers (e.g., a second set of layers that is different from the other second sets of layers).

At 604, a plurality of difference models (e.g., the plurality of difference models 106a-n) can be generated. The plurality of difference models can correspond to the plurality of personalized machine learning models, respectively. For example, each of the plurality of difference models can correspond to one of the plurality of personalized machine learning models. The plurality of difference models can be generated by computing differences between matrices (e.g., high-rank matrices) of the first set of layers and matrices (e.g., high-rank matrices) of the second set of layers. Computing the differences between matrices of the first set of layers and matrices of a particular second set of layers can include calculating the differences between the parameters (e.g., the weights of the parameters) represented by the matrices of the first set of layers and the parameters (e.g., the weights of the parameters) represented by the matrices of the particular second set of layers.

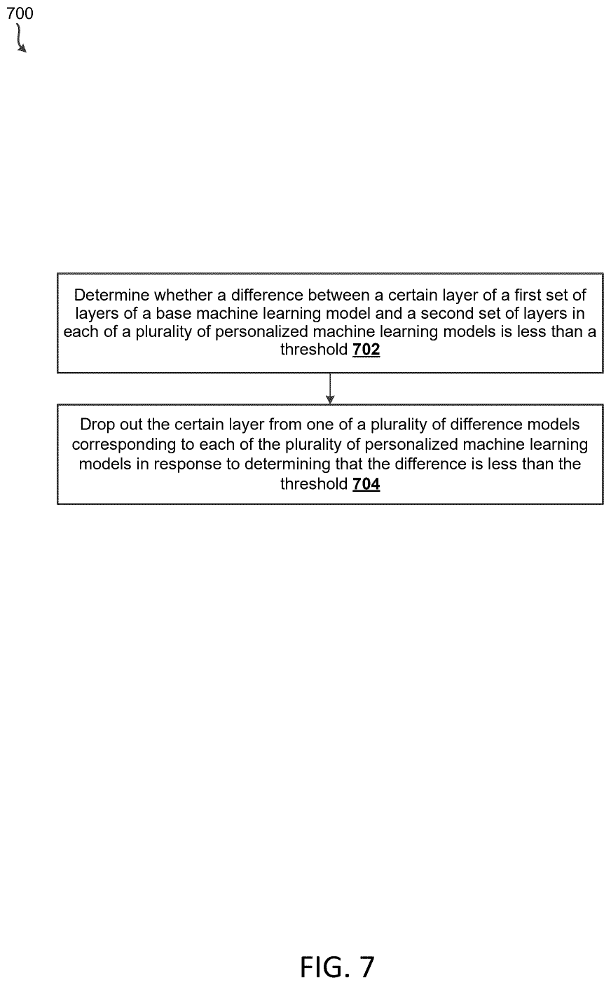

FIG. 7 illustrates an example process 700 for generating difference models in accordance with the present disclosure. Although depicted as a sequence of operations in FIG. 7, those of ordinary skill in the art will appreciate that various embodiments may add, remove, reorder, or modify the depicted operations.

A drop-out mechanism can be implemented during the generation of a plurality of difference models (e.g., the plurality of difference models 106a-n). If a difference between a certain layer of the first set of layers and the second set of layers in at least one of a plurality of fine-tuned machine learning models (e.g., the plurality of fine-tuned machine learning models 104a-n) is less than a threshold, the certain layer can be dropped out from the corresponding different model(s).

At 702, it can be determined whether a difference between a certain layer of a first set of layers of a base machine learning model (e.g., the base machine learning model 102) and a second set of layers in each of the plurality of personalized machine learning models is less than a threshold. For example, it can be determined whether the differences between the parameters of each layer in the first set of layers and the parameters of each corresponding layer in the second set of layers is less than the threshold. At 704, the certain layer can be dropped out from at least one of the plurality of difference models corresponding to at least one of the plurality of personalized machine learning models in response to determining that the difference is less than the threshold.

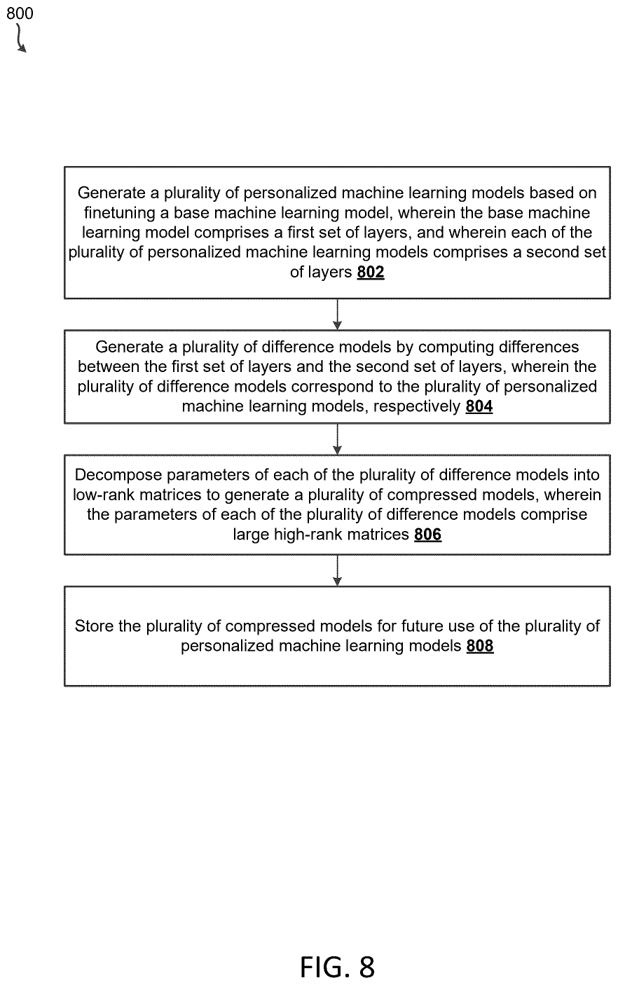

FIG. 8 illustrates an example process 800 for implementing scalable storage of personalized machine learning models in accordance with the present disclosure. Although depicted as a sequence of operations in FIG. 8, those of ordinary skill in the art will appreciate that various embodiments may add, remove, reorder, or modify the depicted operations.

At 802, a plurality of personalized machine learning models (e.g., the plurality of fine-tuned machine learning models 104a-n) can be generated. The plurality of personalized machine learning models can be generated based on finetuning a base machine learning model (e.g., the base machine learning model 102). Each of the plurality of personalized machine learning models can correspond to a particular user from a plurality of users. The base machine learning model can include a first set of layers (e.g., the first set of layers 202a-d). Each of the plurality of personalized machine learning models can include a second set of layers (e.g., the second set of layers 204a-d). Each of the plurality of personalized machine learning models can include a unique second set of layers (e.g., a second set of layers that is different from the other second sets of layers).

At 804, a plurality of difference models (e.g., the plurality of difference models 106a-n) can be generated. The plurality of difference models can correspond to the plurality of personalized machine learning models, respectively. For example, each of the plurality of difference models can correspond to one of the plurality of personalized machine learning models. The plurality of difference models can be generated by computing differences between the first set of layers and the second set of layers. Computing the differences between the first set of layers and a particular second set of layers can include calculating the differences between the parameters (e.g., the weights of the parameters) of the first set of layers and the parameters (e.g., the weights of the parameters) of the particular second set of layers.

The parameters of each of the plurality of difference models can include large high-rank matrices. At 806, parameters of each of the plurality of difference models can be decomposed. The parameters of each of the plurality of difference models can be decomposed into low-rank matrices. The parameters of each of the plurality of difference models can be decomposed to generate a plurality of compressed models (e.g., the plurality of compressed models 108a-n). The plurality of compressed models can include the low-rank matrices.

At 808, the plurality of compressed models can be stored. The plurality of compressed models can be stored in a storage device (e.g., the storage device 110). The plurality of compressed models can be stored for future use of the plurality of personalized machine learning models. Storing the plurality of compressed models instead of the plurality of personalized machine learning models minimizes storage costs without affecting performance quality of the plurality of personalized machine learning models.

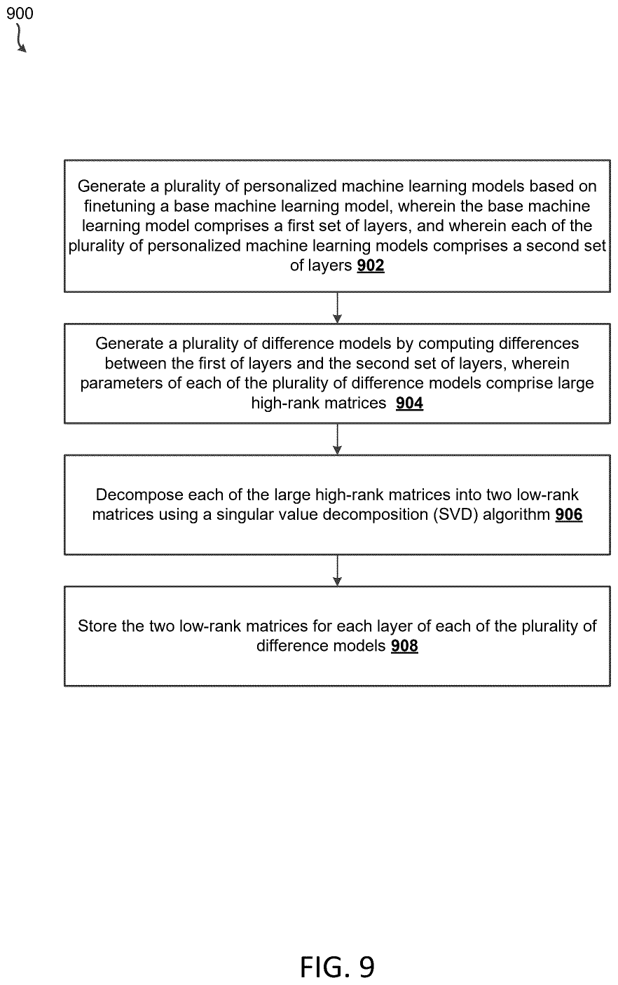

FIG. 9 illustrates an example process 900 for implementing scalable storage of personalized machine learning models in accordance with the present disclosure. Although depicted as a sequence of operations in FIG. 9, those of ordinary skill in the art will appreciate that various embodiments may add, remove, reorder, or modify the depicted operations.

At 902, a plurality of personalized machine learning models (e.g., the plurality of fine-tuned machine learning models 104a-n) can be generated. The plurality of personalized machine learning models can be generated based on finetuning a base machine learning model (e.g., the base machine learning model 102). Each of the plurality of personalized machine learning models can correspond to a particular user from a plurality of users. The base machine learning model can include a first set of layers (e.g., the first set of layers 202a-d). Each of the plurality of personalized machine learning models can include a second set of layers (e.g., the second set of layers 204a-d). Each of the plurality of personalized machine learning models can include a unique second set of layers (e.g., a second set of layers that is different from the other second sets of layers).

At 904, a plurality of difference models (e.g., the plurality of difference models 106a-n) can be generated. The plurality of difference models can correspond to the plurality of personalized machine learning models, respectively. For example, each of the plurality of difference models can correspond to one of the plurality of personalized machine learning models. The plurality of difference models can be generated by computing differences between the first set of layers and the second set of layers. Computing the differences between the first set of layers and a particular second set of layers can include calculating the differences between the parameters (e.g., the weights of the parameters) of the first set of layers and the parameters (e.g., the weights of the parameters) of the particular second set of layers. The parameters of each of the plurality of difference models can include large high-rank matrices. For example, each layer of the plurality of difference models can include a single large high-rank matrix.

At 906, the parameters of each of the plurality of difference models can be decomposed. The parameters of each layer of the plurality of difference models can be decomposed into two low-rank matrices. For example, each single large high-rank matrix can be decomposed into two low-rank matrices. Each of the large high-rank matrices can be decomposed into the two low-rank matrices using a singular value decomposition (SVD) algorithm. Each of the large high-rank matrices can be decomposed to generate a plurality of compressed models (e.g., the plurality of compressed models 108a-n). The plurality of compressed models can include the low-rank matrices.

At 908, the plurality of compressed models can be stored. For example, the two low-rank matrices corresponding to each layer of the plurality of difference models can be stored. The plurality of compressed models can be stored in a storage device (e.g., the storage device 110). The plurality of compressed models can be stored for future use of the plurality of personalized machine learning models. Storing the plurality of compressed models instead of the plurality of personalized machine learning models minimizes storage costs without affecting performance quality of the plurality of personalized machine learning models.

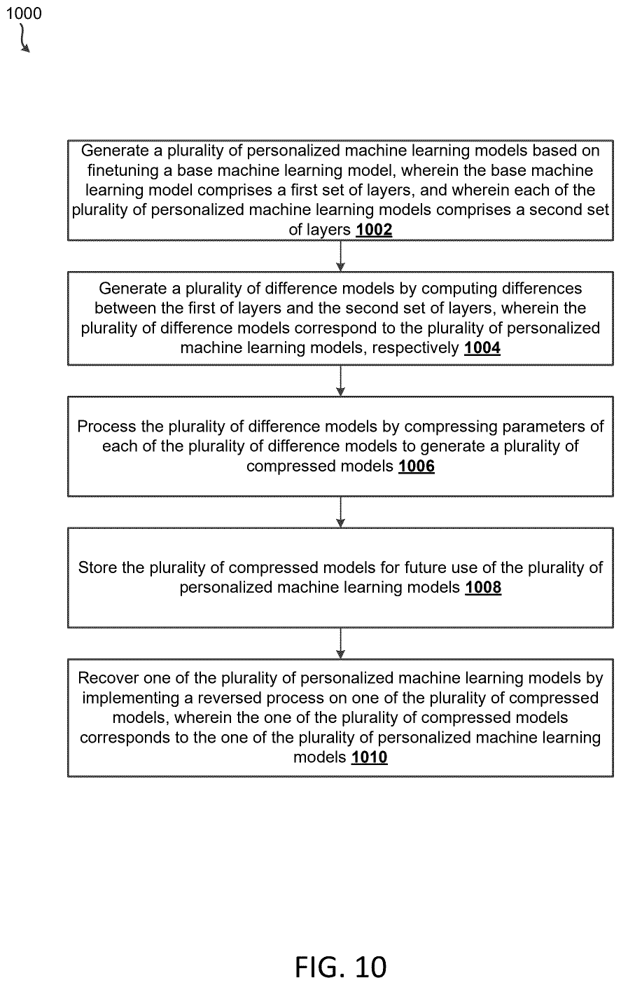

FIG. 10 illustrates an example process 1000 for implementing scalable storage and recovery of personalized machine learning models in accordance with the present disclosure. Although depicted as a sequence of operations in FIG. 10, those of ordinary skill in the art will appreciate that various embodiments may add, remove, reorder, or modify the depicted operations.

At 1002, a plurality of personalized machine learning models (e.g., the plurality of fine-tuned machine learning models 104a-n) can be generated. The plurality of personalized machine learning models can be generated based on finetuning a base machine learning model (e.g., the base machine learning model 102). Each of the plurality of personalized machine learning models can correspond to a particular user from a plurality of users. The base machine learning model can include a first set of layers (e.g., the first set of layers 202a-d). Each of the plurality of personalized machine learning models can include a second set of layers (e.g., the second set of layers 204a-d). Each of the plurality of personalized machine learning models can include a unique second set of layers (e.g., a second set of layers that is different from the other second sets of layers).

At 1004, a plurality of difference models (e.g., the plurality of difference models 106a-n) can be generated. The plurality of difference models can correspond to the plurality of personalized machine learning models, respectively. For example, each of the plurality of difference models can correspond to one of the plurality of personalized machine learning models. The plurality of difference models can be generated by computing differences between the first set of layers and the second set of layers. Computing the differences between the first set of layers and a particular second set of layers can include calculating the differences between the parameters (e.g., the weights of the parameters) of the first set of layers and the parameters (e.g., the weights of the parameters) of the particular second set of layers.

At 1006, the plurality of difference models can be processed. The plurality of difference models can be processed by compressing parameters of each of the plurality of difference models. The plurality of difference models can be processed to generate a plurality of compressed models (e.g., the plurality of compressed models 108a-n). For example, the parameters of a first difference model from the plurality of difference models can be compressed to generate a first compressed model from the plurality of compressed models, the parameters of a third difference model from the plurality of difference models can be compressed to generate a third compressed model from the plurality of compressed models, and so on.

At 1008, the plurality of compressed models can be stored. The plurality of compressed models can be stored in a storage device (e.g., the storage device 110). The plurality of compressed models can be stored for future use of the plurality of personalized machine learning models. Storing the plurality of compressed models instead of the plurality of personalized machine learning models minimizes storage costs without affecting performance quality of the plurality of personalized machine learning models.

If a user from the plurality of users wants to utilize their personalized machine learning model, the corresponding compressed model from the plurality of compressed models can be used to restore (e.g., recover) the personalized machine learning model. At 1010, one of the plurality of personalized machine learning models can be recovered. The personalized machine learning model can be recovered by implementing a reversed process on the corresponding one of the plurality of compressed models.

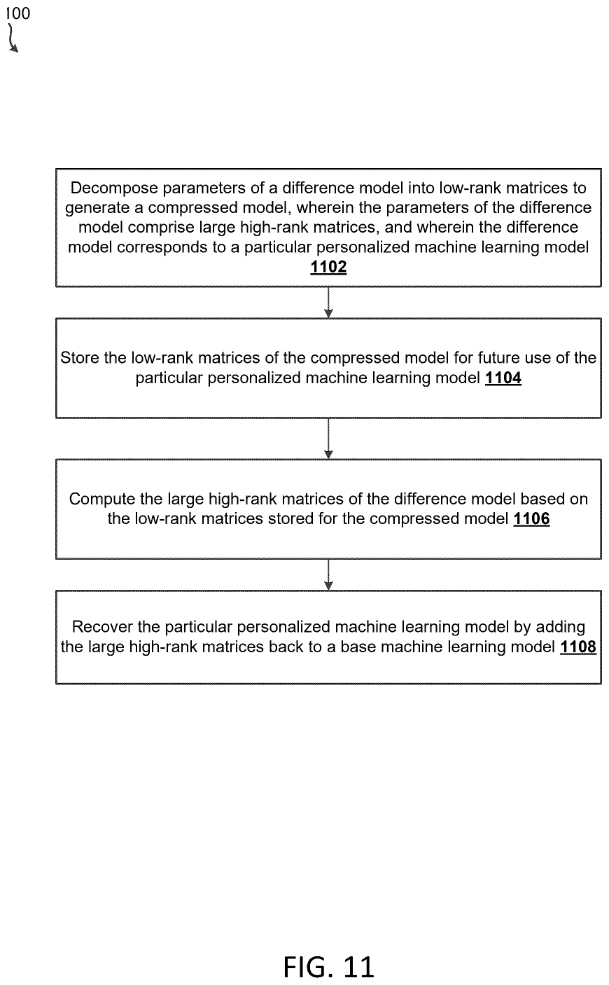

FIG. 11 illustrates an example process 1100 for implementing scalable storage and recovery of personalized machine learning models in accordance with the present disclosure. Although depicted as a sequence of operations in FIG. 11, those of ordinary skill in the art will appreciate that various embodiments may add, remove, reorder, or modify the depicted operations.

A plurality of difference models (e.g., the plurality of difference models 106a-n) can be generated. The plurality of difference models can correspond to a plurality of personalized machine learning models (e.g., the plurality of fine-tuned machine learning models 104a-n), respectively. For example, each of the plurality of difference models can correspond to one of the plurality of personalized machine learning models. The parameters of each of the plurality of difference models can include large high-rank matrices. At 1102, parameters of a particular difference model can be decomposed. The parameters of the difference model can be decomposed into low-rank matrices. The parameters of the difference model can be decomposed to generate a compressed model (e.g., from the plurality of compressed models 108a-n). The compressed model can include the low-rank matrices. At 1104, the compressed model can be stored. The compressed model can be stored in a storage device (e.g., the storage device 110). The compressed model can be stored for future use of the corresponding personalized machine learning model.

If a user from the plurality of users wants to utilize their personalized machine learning model, the corresponding compressed model from the plurality of compressed models can be used to restore (e.g., recover) the personalized machine learning model. At 1106, the large high-rank matrices of the difference model can be computed. The large high-rank matrices of the difference model can be computed based on the low-rank matrices stored for the compressed model. The low-rank matrices can be decompressed into the large high-rank matrices. At 1108, the particular personalized machine learning model can be recovered by adding the large high-rank matrices back to a base machine learning model (e.g., the base machine learning model 102).

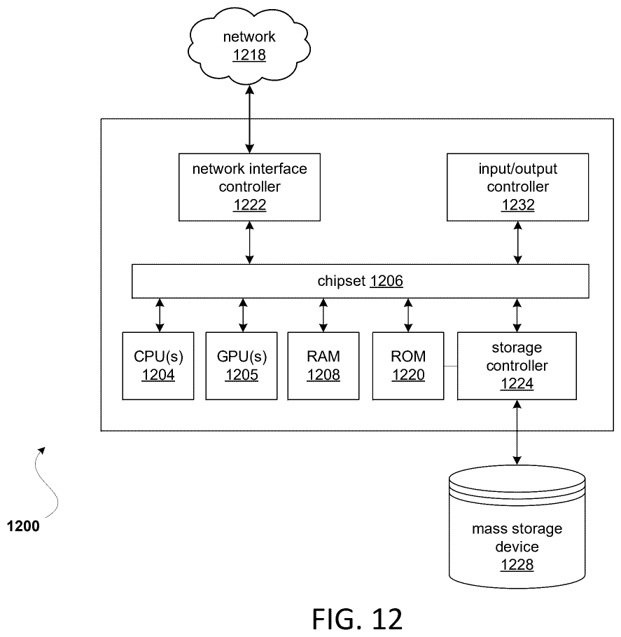

FIG. 12 illustrates a computing device that may be used in various aspects, such as the model(s), components, and/or devices depicted in FIGS. 1-4. With regard to FIGS. 1-4, any or all of the components may each be implemented by one or more instance of a computing device 1200 of FIG. 12. The computer architecture shown in FIG. 12 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1200 may include a baseboard, or “motherboard,” which is a printed circuit board to which a multitude of components or devices may be connected by way of a system bus or other electrical communication paths. One or more central processing units (CPUs) 1204 may operate in conjunction with a chipset 1206. The CPU(s) 1204 may be standard programmable processors that perform arithmetic and logical operations necessary for the operation of the computing device 1200.

The CPU(s) 1204 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1204 may be augmented with or replaced by other processing units, such as GPU(s) 1205. The GPU(s) 1205 may comprise processing units specialized for but not necessarily limited to highly parallel computations, such as graphics and other visualization-related processing.

A chipset 1206 may provide an interface between the CPU(s) 1204 and the remainder of the components and devices on the baseboard. The chipset 1206 may provide an interface to a random-access memory (RAM) 1208 used as the main memory in the computing device 1200. The chipset 1206 may further provide an interface to a computer-readable storage medium, such as a read-only memory (ROM) 1220 or non-volatile RAM (NVRAM) (not shown), for storing basic routines that may help to start up the computing device 1200 and to transfer information between the various components and devices. ROM 1220 or NVRAM may also store other software components necessary for the operation of the computing device 1200 in accordance with the aspects described herein.

The computing device 1200 may operate in a networked environment using logical connections to remote computing nodes and computer systems through local area network (LAN). The chipset 1206 may include functionality for providing network connectivity through a network interface controller (NIC) 1222, such as a gigabit Ethernet adapter. A NIC 1222 may be capable of connecting the computing device 1200 to other computing nodes over a network 1216. It should be appreciated that multiple NICs 1222 may be present in the computing device 1200, connecting the computing device to other types of networks and remote computer systems.

The computing device 1200 may be connected to a mass storage device 1228 that provides non-volatile storage for the computer. The mass storage device 1228 may store system programs, application programs, other program modules, and data, which have been described in greater detail herein. The mass storage device 1228 may be connected to the computing device 1200 through a storage controller 1224 connected to the chipset 1206. The mass storage device 1228 may consist of one or more physical storage units. The mass storage device 1228 may comprise a management component 1210. A storage controller 1224 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1200 may store data on the mass storage device 1228 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1228 is characterized as primary or secondary storage and the like.

For example, the computing device 1200 may store information to the mass storage device 1228 by issuing instructions through a storage controller 1224 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1200 may further read information from the mass storage device 1228 by detecting the physical states or characteristics of one or more particular locations within the physical storage units.

In addition to the mass storage device 1228 described above, the computing device 1200 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1200.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1228 depicted in FIG. 12, may store an operating system utilized to control the operation of the computing device 1200. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1228 may store other system or application programs and data utilized by the computing device 1200.

The mass storage device 1228 or other computer-readable storage media may also be encoded with computer-executable instructions, which, when loaded into the computing device 1200, transforms the computing device from a general-purpose computing system into a special-purpose computer capable of implementing the aspects described herein. These computer-executable instructions transform the computing device 1200 by specifying how the CPU(s) 1204 transition between states, as described above. The computing device 1200 may have access to computer-readable storage media storing computer-executable instructions, which, when executed by the computing device 1200, may perform the methods described herein.

A computing device, such as the computing device 1200 depicted in FIG. 12, may also include an input/output controller 1232 for receiving and processing input from a number of input devices, such as a keyboard, a mouse, a touchpad, a touch screen, an electronic stylus, or other type of input device. Similarly, an input/output controller 1232 may provide output to a display, such as a computer monitor, a flat-panel display, a digital projector, a printer, a plotter, or other type of output device. It will be appreciated that the computing device 1200 may not include all of the components shown in FIG. 12, may include other components that are not explicitly shown in FIG. 12, or may utilize an architecture completely different than that shown in FIG. 12.

As described herein, a computing device may be a physical computing device, such as the computing device 1200 of FIG. 12. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing scalable storage of personalized machine learning models, comprising:
generating a plurality of personalized machine learning models based on finetuning a base machine learning model, wherein each of the plurality of personalized machine learning models corresponds to a particular user from a plurality of users, wherein the base machine learning model comprises a first set of layers, and wherein each of the plurality of personalized machine learning models comprises a second set of layers;
generating a plurality of difference models by computing differences between the first set of layers and the second set of layers, wherein the plurality of difference models correspond to the plurality of personalized machine learning models, respectively;
processing the plurality of difference models by compressing parameters of each of the plurality of difference models to generate a plurality of compressed models; and
storing the plurality of compressed models for future use of the plurality of personalized machine learning models, wherein the plurality of compressed models minimize storage costs without affecting performance quality of the plurality of personalized machine learning models.

2. The method of claim 1, further comprising:
generating each of the plurality of personalized machine learning models by finetuning the base machine learning model based on at least one image received from the particular user.

3. The method of claim 1, further comprising:
generating the plurality of difference models by computing differences between matrices of the first set of layers and matrices of the second set of layers.

4. The method of claim 1, wherein the processing the plurality of difference models further comprises:
determining whether a difference between a certain layer of the first set of layers and the second set of layers in each of the plurality of personalized machine learning models is less than a threshold; and
dropping out the certain layer from one of the plurality of difference models corresponding to each of the plurality of personalized machine learning models in response to determining that the difference is less than the threshold.

5. The method of claim 1, wherein the compressing parameters of each of the plurality of difference models further comprises:
decomposing the parameters of each of the plurality of difference models into low-rank matrices, wherein the parameters of each of the plurality of difference models comprise large high-rank matrices.

6. The method of claim 5, further comprising:
decomposing each of the large high-rank matrices into two low-rank matrices using a singular value decomposition (SVD) algorithm.

7. The method of claim 6, further comprising:
storing the two low-rank matrices for each layer of each of the plurality of difference models.

8. The method of claim 1, further comprising:
recovering one of the plurality of personalized machine learning models by implementing a revered process on one of the plurality of compressed models, wherein the one of the plurality of compressed models corresponds the one of the plurality of personalized machine learning models.

9. The method of claim 8, further comprising:
computing each of large high-rank matrices based on corresponding low-rank matrices stored for the one of the plurality of compressed models; and
recovering the one of the plurality of personalized machine learning model by adding the large high-rank matrices back to the base machine learning model.

10. A system for implementing scalable storage of personalized machine learning models, comprising:
at least one processor; and
at least one memory communicatively coupled to the at least one processor and comprising computer-readable instructions that upon execution by the at least one processor cause the at least one processor to perform operations comprising:
generating a plurality of personalized machine learning models based on finetuning a base machine learning model, wherein each of the plurality of personalized machine learning models corresponds to a particular user from a plurality of users, wherein the base machine learning model comprises a first set of layers, and wherein each of the plurality of personalized machine learning models comprises a second set of layers;
generating a plurality of difference models by computing differences between the first set of layers and the second set of layers, wherein the plurality of difference models correspond to the plurality of personalized machine learning models, respectively;
processing the plurality of difference models by compressing parameters of each of the plurality of difference models to generate a plurality of compressed models; and
storing the plurality of compressed models for future use of the plurality of personalized machine learning models, wherein the plurality of compressed models minimize storage costs without affecting performance quality of the plurality of personalized machine learning models.

11. The system of claim 10, the operations further comprising:
generating each of the plurality of personalized machine learning models by finetuning the base machine learning model based on at least one image received from the particular user.

12. The system of claim 10, the operations further comprising:
generating the plurality of difference models by computing differences between matrices of the first set of layers and matrices of the second set of layers.

13. The system of claim 10, wherein the processing the plurality of difference models further comprises:
determining whether a difference between a certain layer of the first set of layers and the second set of layers in each of the plurality of personalized machine learning models is less than a threshold; and
dropping out the certain layer from one of the plurality of difference models corresponding to each of the plurality of personalized machine learning models in response to determining that the difference is less than the threshold.

14. The system of claim 10, wherein the compressing parameters of each of the plurality of difference models further comprises:
decomposing the parameters of each of the plurality of difference models into low-rank matrices, wherein the parameters of each of the plurality of difference models comprise large high-rank matrices.

15. The system of claim 14, the operations further comprising:
decomposing each of the large high-rank matrices into two low-rank matrices using a singular value decomposition (SVD) algorithm; and
storing the two low-rank matrices for each layer of each of the plurality of difference models.

16. A non-transitory computer-readable storage medium, storing computer-readable instructions that upon execution by a processor cause the processor to implement operations comprising:
generating a plurality of personalized machine learning models based on finetuning a base machine learning model, wherein each of the plurality of personalized machine learning models corresponds to a particular user from a plurality of users, wherein the base machine learning model comprises a first set of layers, and wherein each of the plurality of personalized machine learning models comprises a second set of layers;
generating a plurality of difference models by computing differences between the first set of layers and the second set of layers, wherein the plurality of difference models correspond to the plurality of personalized machine learning models, respectively;
processing the plurality of difference models by compressing parameters of each of the plurality of difference models to generate a plurality of compressed models; and
storing the plurality of compressed models for future use of the plurality of personalized machine learning models, wherein the plurality of compressed models minimize storage costs without affecting performance quality of the plurality of personalized machine learning models.

17. The non-transitory computer-readable storage medium of claim 16, the operations further comprising:
generating the plurality of difference models by computing differences between matrices of the first set of layers and matrices of the second set of layers.

18. The non-transitory computer-readable storage medium of claim 16, wherein the processing the plurality of difference models further comprises:
determining whether a difference between a certain layer of the first set of layers and the second set of layers in each of the plurality of personalized machine learning models is less than a threshold; and
dropping out the certain layer from one of the plurality of difference models corresponding to each of the plurality of personalized machine learning models in response to determining that the difference is less than the threshold.

19. The non-transitory computer-readable storage medium of claim 16, wherein the compressing parameters of each of the plurality of difference models further comprises:
decomposing the parameters of each of the plurality of difference models into low-rank matrices, wherein the parameters of each of the plurality of difference models comprise large high-rank matrices.

20. The non-transitory computer-readable storage medium of claim 19, the operations further comprising:
decomposing each of the large high-rank matrices into two low-rank matrices using a singular value decomposition (SVD) algorithm; and
storing the two low-rank matrices for each layer of each of the plurality of difference models.
